(19) United States
(12) Patent Application Publication
(10) Pub. No.: US 2015/0286972 A1
(43) Pub. Date: Oct. 8, 2015

(54) POP-UP STORE LOGISTICS MANAGEMENT SYSTEM

(71) Applicant: International Business Machines Corporation, Armonk, NY (US)

(72) Inventors: Ajay A. Deshpande, White Plains, NY (US); Kimberly D. Hendrix, New Albany, OH (US); Herbert S. McFaddin, Yorktown Heights, NY (US); Chandrasekhar Narayanaswami, Wilton, CT (US)

(21) Appl. No.: 14/745,670

(22) Filed: Jun. 22, 2015

Related U.S. Application Data
(63) Continuation of application No. 14/510,632, filed on Oct. 9, 2014.
(60) Provisional application No. 61/897,926, filed on Oct. 31, 2013.

(51) Int. Cl. G06Q 10/06; G06Q 10/08

(52) U.S. Cl. CPC G06Q 10/06312; G06Q 10/087

(57) ABSTRACT

According to an aspect, a method for pop-up store logistics management includes receiving locality context information pertaining to a pop-up store in a locality including a weather forecast or a special event associated with the locality. A pop-up store inventory is generated based in part on the locality context information. Inventory records are received from multiple locations where inventory is identified for collection to stock the pop-up store. A pop-up store itinerary is generated including a pick list identifying quantities of items to be collected from inventory, a pick route for walking through a store or distribution center for collecting the items from inventory, and a shelving layout for placing the items into the pop-up store.

### DOMESTIC PRIORITY

The present application claims priority to U.S. Non-provisional patent application Ser. No. 14/510,632, titled “POP-UP STORE LOGISTICS MANAGEMENT SYSTEM” filed Oct. 9, 2014, which claims the benefit of U.S. Patent Application Ser. No. 61/897,926, filed on Oct. 31, 2013, entitled “SYSTEM AND METHOD FOR SETTING UP POP-UP STORES”, the entire contents of which are incorporated herein by reference.

### BACKGROUND

The present disclosure relates generally to retail store logistics systems, and more specifically pertains to a logistics management system for pop-up retail stores.

The increase in popularity of online shopping has increased the competitive pressures on brick-and-mortar retail stores. While online stores have certain advantages, brick-and-mortar stores have their own advantages, including being physically located where their customers are located and having no shipping delay required to place purchased items in the hands of their customers (real-time fulfillment). As online retailers increase in popularity, brick-and-mortar stores are searching for ways to leverage their own advantages to thrive in the modern competitive environment.

### SUMMARY

Embodiments include a method, system, and computer program product for logistics management for pop-up stores. A method for pop-up store logistics management includes receiving locality context information pertaining to a pop-up store in a locality including a weather forecast or special events associated with the locality. Other locality information would include traditional aspects like consumer demographics and competitor location data. A pop-up store inventory is generated based in part on the locality context information. Inventory records are received from one or more locations where inventory is identified for collection to stock the pop-up store. A pop-up store itinerary is generated including a pick list identifying quantities of items to be collected from inventory, a pick route for navigating through a store or distribution center for collecting the items, or bins or pallets of items from inventory, and a shelving layout for placing the items into the pop-up store.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a logistics management system for a retail pop-up store in accordance with an embodiment.

FIG. 2 depicts a mobile pop-up store utilizing a logistics management system in accordance with an embodiment.

FIG. 3 depicts a logic flow diagram for a logistics management procedure for a retail pop-up store in accordance with an embodiment.

FIG. 4 depicts a logic flow diagram for receiving itinerary scheduling information for a retail pop-up store in accordance with an embodiment.

FIG. 5 depicts a logic flow diagram for determining a pop-up store itinerary in accordance with an embodiment.

FIG. 6 depicts an item pickup route for a pop-up store logistics management system in accordance with an embodiment.

FIG. 7 depicts a routing menu for a pop-up store logistics management system in accordance with an embodiment.

FIG. 8 depicts a processing system suitable for implementing one or more components of the pop-up store logistics management system in accordance with an embodiment.

### DETAILED DESCRIPTION

Embodiments described herein relate to a logistics management system for a retail pop-up store. The system can be used for mobile pop-up stores, off-site temporary stores (e.g., tent areas at local venues), as well as pop-up store sections located on the grounds (e.g. tent area in parking lot) or inside the host store (e.g., a special section set aside for special inventory). The logistics management system determines inventory for the pop-up store based on locality context information, such as weather, local events, traffic, special needs of the locality, sales history, demographic, holidays, and so forth. Additional stocking factors include the current inventory in the pop-up store, inventory available in the host store, inventory available at nearby stores and distribution centers, pricing and assortment range, and product profit margins. Item weight, volume, fragility, shelf life, and perishability constitute some other factors. Based on these factors, the logistics management system determines one or more pick lists for stocking the pop-up store from inventory held in one or more locations, such as stores and distribution centers. Each pick list may include a pick route shown on a store or distribution center map displayed on mobile device assigned to a pop-up store associate to facilitate efficient collecting of the items from inventory. The logistics management may also schedule events and provide travel routes shown on a road map displayed on mobile device to facilitate efficient travel between stocking and sale venue locations.

The pop-up store itinerary is transmitted to a mobile device associated with the pop-up store. Log-in inventory registration messages indicate placement of the items into, and log-out inventory registration messages indicating removal of the items out of, the pop-up store. Additionally, when the pop-store returns to the retail store, a put-back list of items left over may be generated and a route for navigating through the store or distribution center for shelving the items back may be generated.

Technical effects and benefits include the ability to efficiently provision pop-up stores allowing a host store to have carefully selected inventory immediately available to meet the likely needs customers based on locality context information. For example, a mobile pop-up store carried on a truck can be dispatched to a construction site to improve sales of tools, hardware and construction materials. Another mobile pop-up store can be dispatched to a professional sporting game with items targeted for fans attending the game, and another to a fishing tournament with gear and provisions targeted for participants in that event. Additional examples include pop-up stores stocked and dispatched to areas affected by severe weather, refugee displacement, political gatherings, religious festivals, cultural events, campus events, and virtually any other type of event or condition that warrants a pop-up store effort in the view of the store proprietor.

The pop-up store inventory can be easily adjusted to take account of a wide range local context factors, such as the weather forecast, demographic factors, holidays, and so forth. Mobile pop-up stores and on-site store sections are thus turned into highly nimble retail outlets configured to have the right inventory in the right locations at the right times to improve sales and customer recognition. This provides retail stores with the ability to leverage a major competitive asset, which is the ability to strategically place carefully selected inventory in carefully selected physical locations to increase sales.

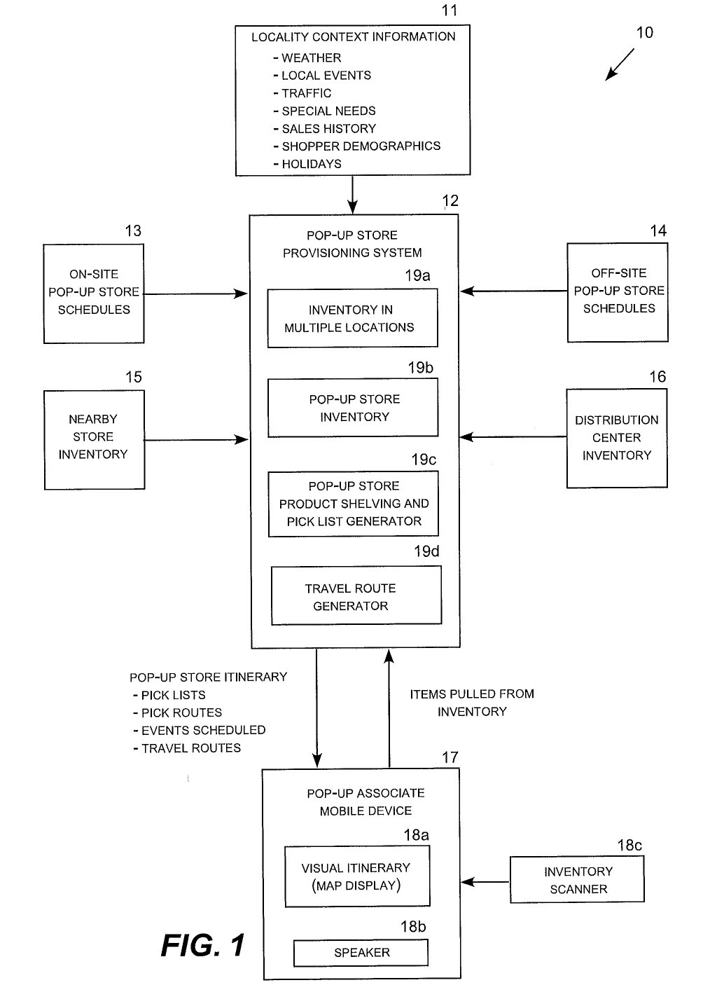

Turning now to FIG. 1, a logistics management system 10 for a pop-up store includes locality context information 11, a pop-up store provisioning system 12, and a pop-up store associate mobile device 17. The mobile device 17 runs a software application and includes a display 18a, speaker 18b, and inventory control device 18c that allows the pop-up store associate to interact with the provisioning system 12 to manage the stocking and dispatch of the pop-up store. The functionality of this embodiment is largely indifferent to the type of computing devices or network architecture used to implement the functionality. In one particular embodiment, the pop-up store provisioning system 12 may be a desktop or laptop computer utilizing running on a server and providing access to the mobile device 17 over a network, such as the Internet. The mobile device 17 may be a smartphone utilizing an app to access the provisioning system over a wifi or other suitable network connection. As another example, the mobile device 17 may include a tablet or other type of computer mounted within a vehicle carrying or supporting the pop-up store. It will be appreciated that any other computer environment allowing a mobile store associate to communicate with a stationary or centralized logistics management system for a host store may be used to realize embodiments of the invention.

The locality context information 11 includes one or more data sources, such as live information feeds, portals, and stored records. Typical data sources provide information regarding the local weather forecast in the locality of a host retail store. Weather-based pop-up store stocking and dispatching is an important advantage that brick-and-mortar stores have over online retailers. The weather forecast is used to strategically select inventory for the pop-up stores and dispatch them to the most advantageous venues. For example, rainy weather may influence the pop-up store to stock rain gear, hot and sunny weather to stock sunscreen and coolers, cold weather to stock heavy clothing and hand warmers, and so forth. Hot weather in the summer may influence a pop-up store to stock bathing products and head to the beach, while snow may influence a pop-up store to stock tire chains and heavy clothing and head to mountain passes and ski resorts. The pop-up store may also be recalled or instructed to take protective measures in advance of bad weather.

Data feeds such as news services covering local events can be used to schedule pop-up stores to stock items selected specifically for the local events. For example, logo clothing, folding chairs, charcoal and other party provisions can be stocked for a pop-up store dispatched to a tailgating area for a major sporting event. Clothing with logos or colors favored by the visiting sporting teams can also be stocked when a large contingent of visiting fans are expected to be in town. Fishing gear, ice, packaged food, and marine electronics can be stocked for a pop-up store dispatched to a marina where a fishing tournament is scheduled. Business supplies, telecommunication gear, and presentation equipment can be stocked in a pop-up store dispatched a convention site. Construction materials, tools and hardware material can be stocked for a pop-up store dispatched to a construction site. The pop-up stores may be, need not necessarily be mobile as it may be similarly advantageous to provision a brick-and-mortar pop-up store located near a special event, for example with a parking lot pop-up tent or special store section stocking goods targeted for a special event taking place nearby.

A local traffic data feed may be instrumental when scheduling travel routes and site location decisions for a mobile pop-up store. Heavily congested roadways may be avoided when routing a mobile pop-up store on stocking runs and from one venue to another during the course of a day. For example, heavy traffic may be avoided for a pop-up store dispatched to a public beach site in the morning and relocated to a sporting event in the evening. The mobile store may also be routed for one or more restocking stops along the way to replenish depleted items and pick up items targeted for the second venue. As another example, a mobile pop-up store (or a stocking vehicle for an on-site pop-up store) may be routed to avoid congested roadways when making a stocking run to several. A final example is to locate a pop-up store where there are crowds gathered or expected, and/or highly trafficked locations with large numbers of potential consumers of the product offering located nearby a given site. Unlike online retailers, monitoring traffic conditions allows the logistics system to flexibly dispatch pop-up stores to follow the crowds, weather-related events, and other conditions to take advantage of in-person sales opportunities as conditions on the ground change.

Special needs of a particular community can also be taken into account when provisioning pop-up stores. The presence of particular universities, employers, ethnic groups, fan bases, hospitals, cultural events, weather-related disasters and other man-made and natural conditions may influence the items stocked in a particular pop-up store. As additional examples, a pop-up store may be strategically stocked and dispatched to an area affected by storm damage, flood damage, or the presence of refugees. A large hospital, employer, construction project, or ethnic population residing or temporarily located in the area may influence the items stocked in a pop-up store. A wide range of other factors may be taken into account when identifying items to stock in pop-up stores. A few additional illustrative examples include sales history for the areas, demographics of people living in the areas, demographics of people expected to be visiting or displaced to the area, school schedules, and holidays.

Profit margin and expected turnover are also important considerations when stocking items in a limited shelf space available in a pop-up store. The objective of this disclosure is not to catalog all possible inventory stocking factors that may be relevant for a particular retailer, as that list will be highly varied and specific for different vendors and locals. Rather, the disclosure is directed to logistics management systems and associated methods that can be tailored to take a wide range of factors to take into account when stocking and dispatching pop-up stores to leverage a retailer's available inventory, shelf space, special-purpose store sections, parking lot tents, off-site sales venue, trucks and other resources to maximize sales opportunities.

An illustrative pop-up store provisioning system 12 receives the locality context information 11 along with inventory information from a variety of sources, such an onsite pop-up store schedules 13, off-site pop-up store schedules 14, nearby store inventory 15, and distribution center inventory 16. This allows the provisioning system 12 to coordinate logistics for one or more on-site and off-site pop-up stores that may service multiple venues with inventory that may be located in a number of stores and distribution centers. The illustrative pop-up store provisioning system 12 for a host store maintains a consolidated inventory 19a for items located in multiple places, typically including a retail sales floor and store room located in the host store, as well as inventory held in one or more off-site inventory locations, such as nearby stores and distribution centers.

The system 12 also maintains a running inventory for each pop-up store managed by the system. The system 12 also includes product shelving and pick list generator 19c for the pop-up store that itemizes specific products to be picked up from various inventory locations and stored on specific shelf locations in the pop-up store. Barcode, QR code, RFID or other inventory management techniques are used to track the products as they are moved from prior inventory locations into the pop-up stores. Inventory scanners are similarly utilized to track inventory items as they are received or sold from the stores to provide real-time visibility of the pop-up store inventory throughout the stocking and sales cycle. The system 12 also includes a travel route generator 19d for any pop-up stores or trucks used to pick up inventory for pop-up stores.

The pop-up store provisioning system 12 communicates with the pop-up store assistant mobile device 17 to monitor and manage the pop-up store logistics process. The pop-up store provisioning system 12 provides overall logistics management, while the pop-up store assistant mobile device 17 provides an associate operating a particular pop-up store with specific instructions for operating the pop-up store. It will be appreciated that a single pop-up store provisioning system may interface with one or more mobile devices. Similarly, a single pop-up store provisioning system may provide centralized management for multiple host stores and multiple pop-up stores. In this particular example, one system 12 is shown in connection with one mobile device 17 for one pop-up store to illustrate the principles of the present disclosure. It will be appreciated that the same principles may be applied to multiple host stores, multiple mobile devices, and multiple pop-up stores as a matter of design choice.

In this embodiment, the pop-up store is configured as a mobile truck and the pop-up store provisioning system 12 provides the mobile device 17 assigned to the mobile store with pick lists, pick routes, events scheduled, and travel routes. The pick lists identify specific items and quantities to be picked up at one or more stocking locations. The pick routes provide store product location maps and associated routes directing an associate on efficient routes through the stocking location enabling the associate to quickly locate and collect the inventory assigned to the pop-up store. Inventory may be collected from one or more distribution centers and/or one or more retail stores in an efficient manner. At a particular store, the pick route directs the associate on a walking route to collect products from the store room and retail sales floor in an efficient manner. The events schedules identify the sales venues assigned to the pop-up store and the travel routes provide efficient driving navigation to the various stocking locations and sale venues. The mobile device 17 typically includes a navigation display 18a and/or audio speaker 18b that direct the walking pick routes within stores and distribution center as well as and driving routes between these locations and sales venues.

The pop-up associate mobile device 17 may also include an inventory scanner or a connection (e.g., wireless interface) to a physically separate inventory scanner 18c, such as a cash register barcode scanner and/or an inventory scanner. The inventory scanner 18c allows the mobile device 17 keep track of products entered into and removed from the pop-up store inventory. The mobile device 17 also informs the pop-up store provisioning system 12 when items are placed into and pulled from the pop-up store inventory. As another option, shoppers may be directed to pass through product RFID scanners that are cordoned off to the pop-up store to detect when items logged into the pop-up store inventory pass through the scanner. This allows the mobile device 17 to serve as a local inventory control system for the pop-up store to assist in inventory surveillance and automated checkout for registered customers.

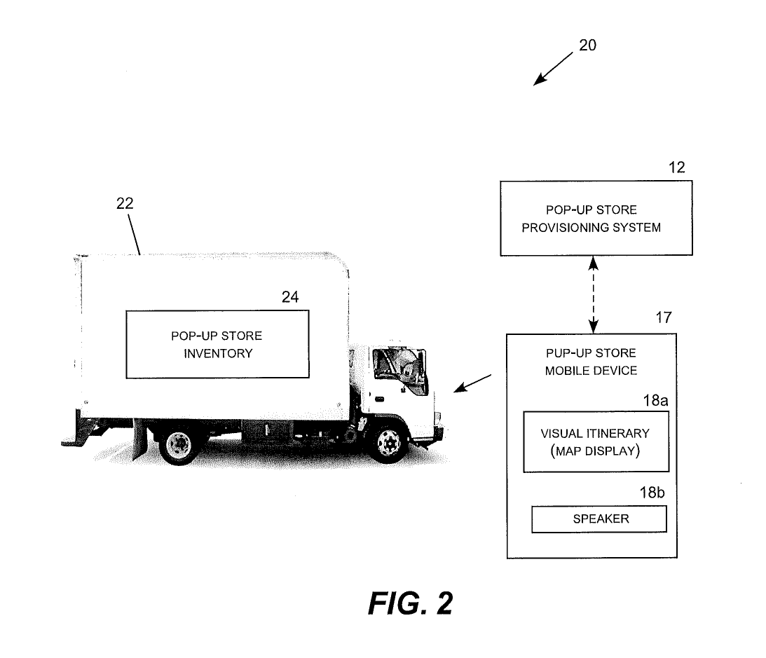

FIG. 2 depicts an illustrative mobile pop-up store 20 utilizing a logistics management system 10 in accordance with an embodiment. The mobile pop-up store 20 is carried in a truck 22 that contains the pop-up store inventory 24. The truck may also contain non-merchandise inventory such as tables, chairs, display shelves, canopies, displays, demonstration stations, shopping bags, and so forth. The pop-up store 20 or an associate assigned to the pop-up store carries the mobile device 17 assigned to or installed in the truck 22. The mobile device 17 continually communicates with the pop-up store provisioning system 12 as it travels and stops on its assigned itinerary. The provisioning system 12 is typically located at a host brick-and-mortar store or a central dispatching location, while the mobile device 17 provides logistics including inventory management, product pickup instructions, and travel routing instructions for the mobile pop-up store 20.

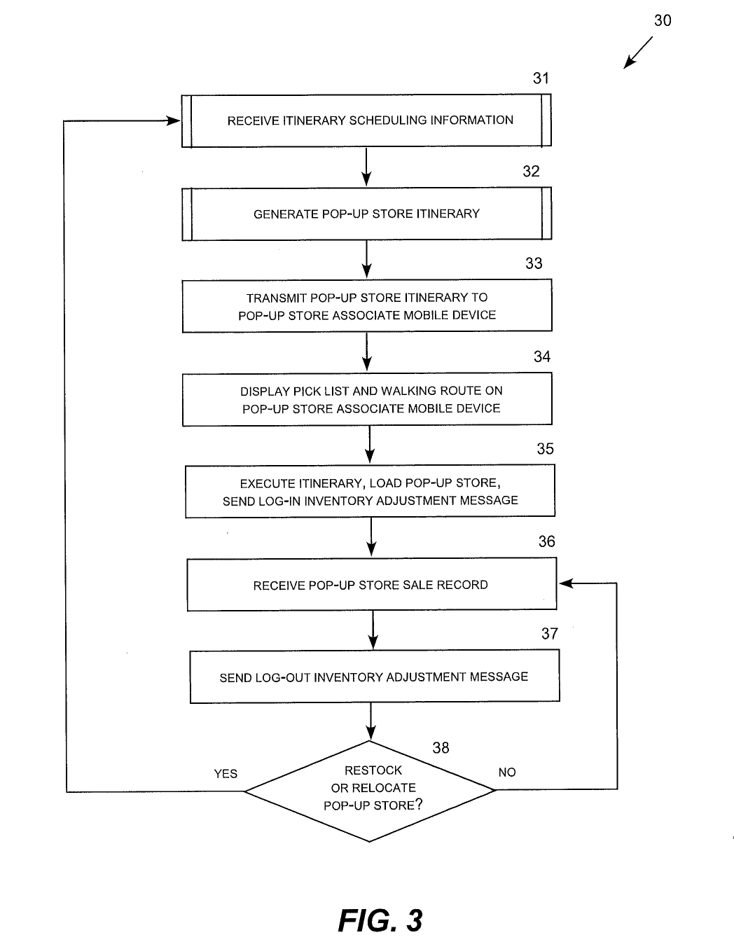

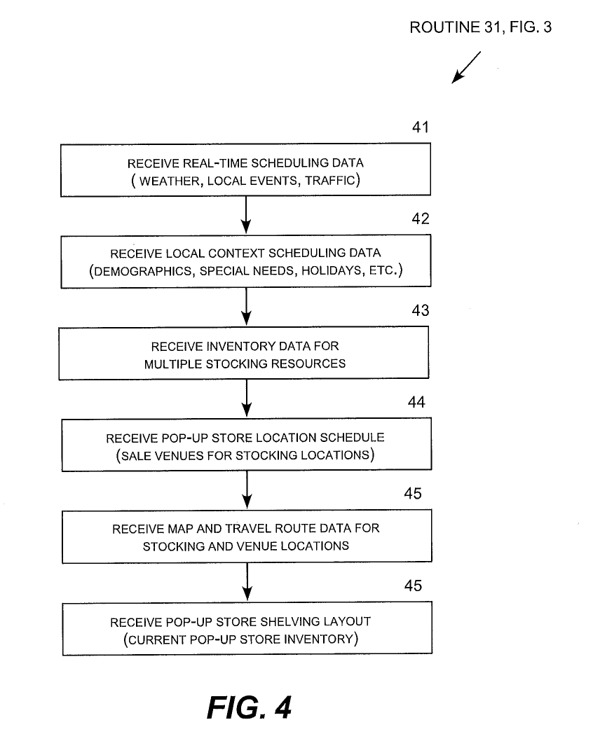

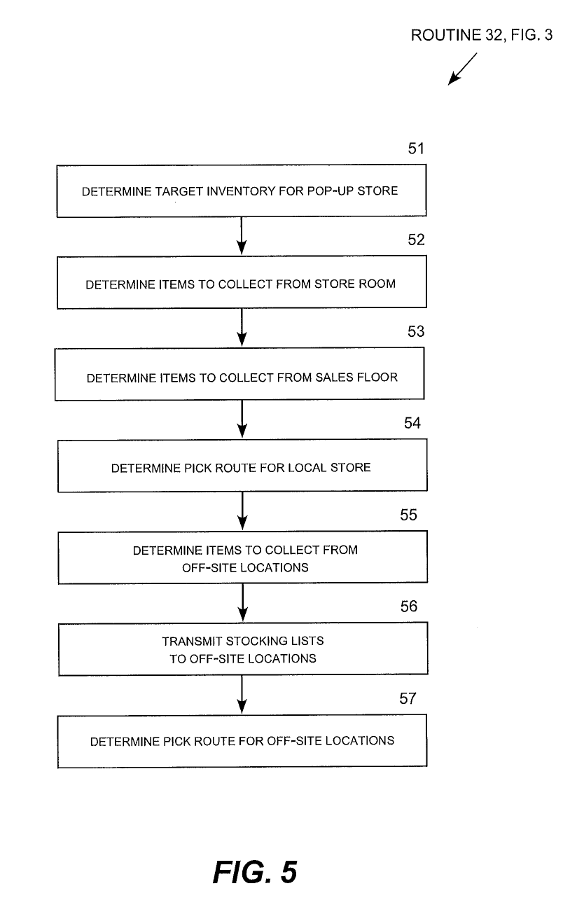

FIG. 3 depicts a representative logic flow diagram 30 suitable for the logistics management system 10 for the retail pop-up store 20 in accordance with an embodiment. Reference will also be to FIG. 1 in the following description of the logic flow diagram 30. In block 31, the provisioning system 12 receives itinerary scheduling information as described in greater detail with reference to FIG. 4. In block, 32, the provisioning system 12 generates a pop-up store itinerary as described in greater detail with reference to FIG. 5.

In block 33, the provisioning system 12 transmits the pop-up store itinerary to a mobile device 17 assigned to the pop-up store. In block 34, the mobile device 17 displays a pick list and a walking route to guide an associate on an efficient path through a store when collecting items from the store for placing into the pop-up store. In block 35, the associate executes the pick list by walking through the store, collecting the items for the pop-up store, and scanning them into inventory in the pop-up store. The mobile device 17 and the provisioning system 12 keep track of the inventory items loaded to the pop-up store through log-in inventory registration messages from the mobile device to the provisioning system indicating placement of the items into the pop-up store. In block 36, a product is removed from the pop-up store inventory, typically as a result of the sale of the product. In block 37, the mobile device 17 scans the removed item (or receives notification from a cooperating scanning device) and communicates a log-out inventory message to the pop-up store provisioning system 12. This allows the mobile device 17 and the provisioning system 12 to track the inventory located in the pop-up store. The mobile device 17 thus maintains an inventory manifest for its associated pop-up store regardless of communication status. The provisioning system 12 receives inventory log-in and log-out records when communications are active with the pop-up, which may be intermittent in some locations. This allows the provisioning system to coordinate inventory management for a number of host stores, pop-up stores, and distribution centers.

In block 38, the mobile device 17 or the provisioning system 12 determines whether to restock or relocate the pop-up store. If the pop-up store is not to be restocked or relocated, the “no” branch is followed to step 36 for continued sales from the pop-up store. If the pop-up store is to be restocked or relocated, the “yes” branch is followed to step 32 for receipt of new itinerary information. This allows the provisioning system 12 to manage the pop-up store in real time, which may involve recalling the pop-up store for restocking and directing the pop-up store to a new location and stopping to pick up inventory or modify staffing on the way. As a result, the provisioning system 12 may serve as a flexible logistics management and dispatch center for a number of brick-and-mortar stores, a number of pop-up stores, and a number of distribution centers.

FIG. 4 depicts a logic flow diagram for routine 31 on FIG. 3 for receiving itinerary scheduling information for a retail pop-up store. In block 41, the provisioning system 12 receives real-time scheduling data, such as data feeds and news services communicating weather, local events, and traffic data for the locality where the pop-up store is located. In block 42, the provisioning system 12 receives additional local context data, such as demographic information, special needs, and holidays for the locality or visitors to the locality where the pop-up store is located. In block 43, the provisioning system 12 receives inventory data for multiple stocking locations, such as inventory on the retail floor of the host store, inventory in a store room location at the host store, inventory on the sales floors at nearby stores, inventory in the store room at the nearby stores, and inventory at nearby distribution centers. Local suppliers, cooperating vendors, and sources of non-stocked equivalents and alternative products may also be considered as potential inventory sources for pop-up stores. In block 44, the provisioning system 12 receives a schedule for the pop-up store, which may include vending at one or more off-site venues. In block 45, the provisioning system 12 receives map and routing data for sale venues and stocking locations for the pop-up store. In block 45, the provisioning system 12 receives a shelving layout (planogram or floorset) for the pop-up store. Any other information considered relevant for provisioning the pop-up store is collected.

FIG. 5 depicts a logic flow diagram for routine 32 on FIG. 3 for determining an itinerary for the pop-up store itinerary. In block 51, the provisioning system 12 determines target inventory for the pop-up store taking the itinerary scheduling information described above into account. Inventory specifies number of units, package sizes, and may include manufacturing batch numbers, etc. The type of event(s) where the pop-up store is scheduled to vend, the weather forecast, demographic information about the locality, the demographics of crowds expected at the event(s), prior sales history for the event(s), product availability, and product profit margins will play important roles in selecting the inventory to be stocked in the limited selling space of the pop-up store. While the optimum inventory will vary depending on the specific situation, the guiding objectives will be maximizing profits at all affected sales locations (e.g., the pop-up store as well as the pop-up venue), maintaining adequate inventory at all affected sales locations, and building customer recognition and loyalty.

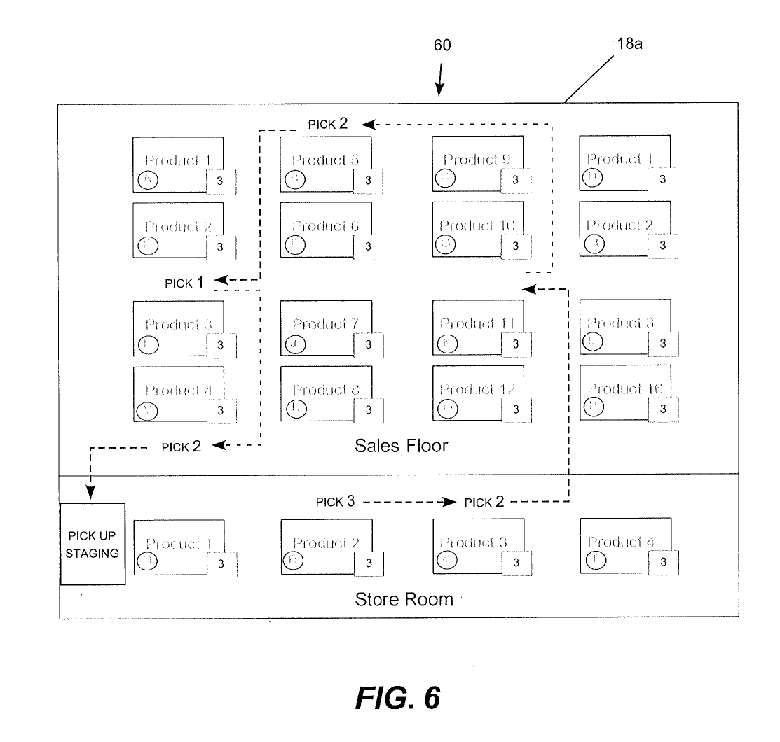

FIG. 6 depicts an item pickup route 60 provided on the display 18a of the mobile device 17 carried by a pop-up store associate in accordance with an embodiment. The item pickup route 60 shows a path for an associate to walk through a retail store while identifying items and quantities to be picked up at various storage locations. The walking path guides the associate along an efficient collection route through a store room and a retail sales floor area. A similar route may be provided for more than one store and/or distribution center to collect products assigned to the pop-up store. It will be appreciated that another store or distribution center employee may be assigned to collect the items assigned to the pop-up store and set them aside for pick up by the pop-up store associate. In this case, the pop-up store mobile device 17 may notify a pickup location of an estimated time of arrival and when the truck is on the way to the store. The pickup location may also notify the mobile device 17 when an order for the pop-up store is ready for pickup. An RFID reader housed in or cooperating with the mobile device 17 may be provided to simultaneously read the tags on multiple items in a pickup bin to speed product registration into the pop-up store.

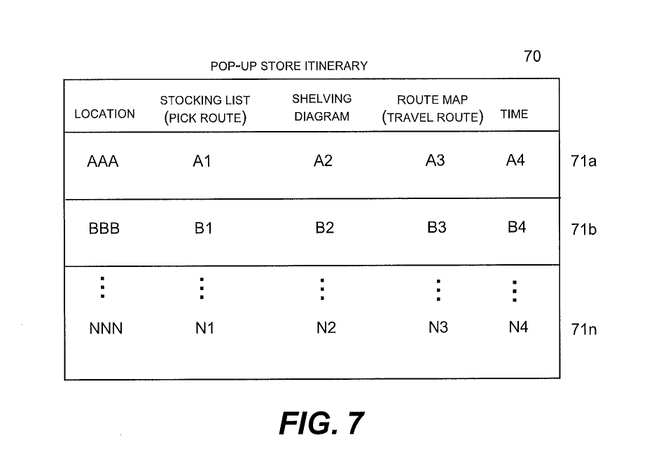

FIG. 7 depicts a routing menu 70 for the pop-up store logistics management system 10 in accordance with an embodiment. This example includes a list of itinerary records 71a-n that each include a number of itinerary items. Each itinerary record includes a pickup location, a stocking list for the location, a shelving or selling space diagram for stocking the picked up items in the pop-up store, a route map for driving to the location, and a scheduled time of arrival. Each itinerary item in this example is depicted as a link that can be selected to obtain additional information. To illustrate the type of information that may be available, the location link may be selected to obtain name, address, contact information, and contact person for the location (e.g., store or distribution center). The stocking list link may be selected to obtain the items to be collected at the store (pick list), the route to be walked when collecting the items (pick route), and whether the items have already been collected and are ready for pickup and the bin, locker or other area where the items have been placed for pickup. The shelving diagram link may be selected to obtain a diagram or list indicating where the items to be collected are to be stocked in the pop-up store. The travel route link may be selected to obtain a driving map for navigating to the pickup location. Similar line items may be included for sale locations.

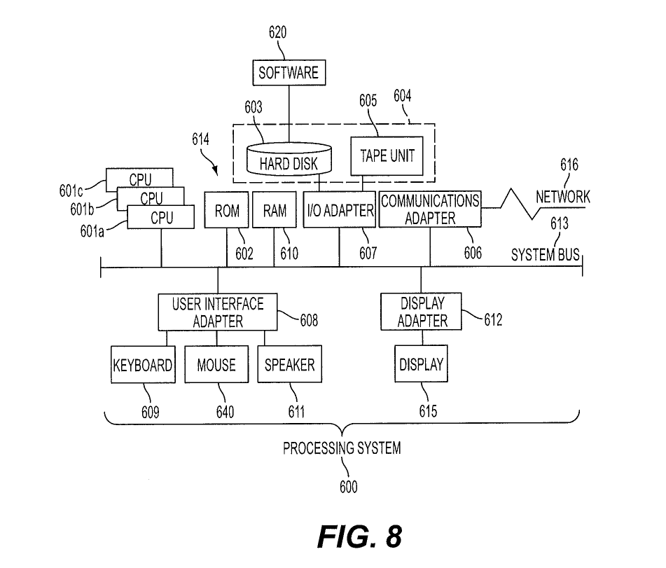

FIG. 8 depicts a processing system suitable for implementing the pop-up store logistics management system in accordance with an embodiment. The pop-up store provisioning system 12 and the pop-up store associate mobile device 17 may both be configured as described below. It will be appreciated that this particular computer configuration is merely illustrative and wide range of platforms can be used to implement these components as a matter of design choice.

Referring now to FIG. 8, there is shown an embodiment of a processing system 600 for implementing the teachings herein. In this embodiment, the processing system 600 has one or more central processing units (processors) 601a, 601b, 601c, etc. (collectively or generically referred to as processor(s) 601). Processors 601, also referred to as processing circuits, are coupled to system memory 614 and various other components via a system bus 613. Read only memory (ROM) 602 is coupled to system bus 613 and may include a basic input/output system (BIOS), which controls certain basic functions of the processing system 600. The system memory 614 can include ROM 602 and random access memory (RAM) 610, which is read-write memory coupled to system bus 613 for use by processors 601.

FIG. 8 further depicts an input/output (I/O) adapter 607 and a network adapter 606 coupled to the system bus 613. I/O adapter 607 may be a small computer system interface (SCSI) adapter that communicates with a hard disk 603 and/or tape storage drive 605 or any other similar component. I/O adapter 607, hard disk 603, and tape storage drive 605 are collectively referred to herein as mass storage 604. Software 620 for execution on processing system 600 may be stored in mass storage 604. The mass storage 604 is an example of a tangible storage medium readable by the processors 601, where the software 620 is stored as instructions for execution by the processors 601 to perform a method, such as the process flow of FIGS. 3-5. Network adapter 606 interconnects system bus 613 with an outside network 616 enabling processing system 600 to communicate with other such systems. A screen (e.g., a display monitor) 615 is connected to system bus 613 by display adapter 612, which may include a graphics controller to improve the performance of graphics intensive applications and a video controller. In one embodiment, adapters 607, 606, and 612 may be connected to one or more I/O buses that are connected to system bus 613 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 613 via user interface adapter 608 and display adapter 612. A keyboard 609, mouse 640, and speaker 611 can be interconnected to system bus 613 via user interface adapter 608, which may include, for example, a Super I/O chip integrating multiple device adapters into a single integrated circuit.

Thus, as configured in FIG. 8, processing system 600 includes processing capability in the form of processors 601, and, storage capability including system memory 614 and mass storage 604, input means such as keyboard 609 and mouse 640, and output capability including speaker 611 and display 615. In one embodiment, a portion of system memory 614 and mass storage 604 collectively store an operating system such as the AIX® operating system from IBM Corporation to coordinate the functions of the various components shown in FIG. 8.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for pop-up store logistics management, comprising:
receiving locality context information pertaining to a pop-up store in a locality including a weather forecast or a special event associated with the locality;
generating a pop-up store inventory based in part on the locality context information; and
receiving inventory records from one or more locations where inventory is identified for collection to stock the pop-up store.

2. The method of claim 1, further comprising:
generating a pop-up store itinerary including a pick list identifying quantities of items to be collected from inventory, a pick route for walking through a store or distribution center for collecting the items from inventory, and a shelving or selling floor layout for placing the items into the pop-up store;
transmitting the pop-up store itinerary to a mobile device associated with the pop-up store;
receiving log-in inventory registration messages indicating placement of the items into the pop-up store;
receiving log-out inventory registration messages indicating removal of the items from the pop-up store;
receiving a list of remaining inventory after the pop-up store is recalled; and
generating an itinerary to load the remaining inventory back to the shelves in a store or a distribution center.

3. The method of claim 2, wherein the pick route guides an associate through host store and the pop-up store is a designated area inside or on the grounds of the host store.

4. The method of claim 2, wherein the pick route guides an associate through multiple stores and/or distribution centers, and the itinerary further comprises a travel route between the multiple stores and/or distribution centers.

5. The method of claim 1, wherein the pop-up store is a mobile store assigned to travel and sell products at a special event located remotely from a host store providing inventory carried on the pop-up store.

6. The method of claim 1, wherein the locality context information used to generate the pop-up store inventory further comprises demographic information regarding residents of the locality or expected visitors to the locality associated with the special event.

7. The method of claim 1, wherein the special event comprises a sporting event, convention, construction project, school schedule, campus event, cultural event, or weather-related disaster.
